(19) United States
(12) Patent Application Publication
(10) Pub. No.: US 2026/0228241 A1
(43) Pub. Date: Aug. 6, 2026

(54) METHOD OF ASSOCIATING GEODATA WITH A COLLECTION OF DISPLAY TEMPLATES

(71) Applicant: FNV IP B.V., Leidschendam (NL)

(72) Inventors: Jorg DONAT, Leidschendam (NL); Rene SCHMOHL, Leidschendam (NL)

(73) Assignee: FNV IP B.V., Leidschendam (NL)

(21) Appl. No.: 19/154,044

(22) PCT Filed: Feb. 12, 2024
(86) PCT No.: PCT/EP2024/053413

§ 371 Date: Aug. 6, 2025

(30) Foreign Application Priority Data
Feb. 13, 2023 (NL) 2034138

(51) Int. Cl. G06F 16/28

(52) U.S. Cl. CPC G06F 16/287

(57) ABSTRACT

A computer-implemented method of associating geodata with a collection of display templates is disclosed. The method comprises receiving a selection of two or more display templates configured to graphically represent geodata, grouping the selected display templates into a display template collection, receiving a selection of a first database object comprising geodata, creating a connection between the display template collection and the first database object to enable the geodata to be retrieved from the first database object to the display template collection, and populating the display templates within the display template collection with the geodata retrieved from the first database object. Unlocking insights from Geo-Data, the present invention further relates to improvements in sustainability and environmental developments: together we create a safe and livable world.

### FIELD

The disclosure relates to methods and systems for associating geodata with display templates. More particularly, the disclosure relates to a method and system for visualising and representing geodata stored in a database in a more effective and intuitive manner which facilitates comparison of data and identification of patterns, trends, and correlations within the geodata in an efficient manner. In addition, the disclosure relates to methods and systems for retrieving, combining and displaying a variety of types of geodata in an efficient and intuitive manner. Unlocking insights from Geo-Data, the present invention further relates to improvements in sustainability and environmental developments: together we create a safe and livable world.

### BACKGROUND

There is a general and ongoing need for systems and methods for determining sub-surface ground parameters. In particular, there is a need for systems and methods that can be used to model the properties of a target volume beneath the surface of the earth to provide information useful for infrastructure planning. There is also a need to determine sub-surface soil composition and structure. Determination of sub-surface ground properties in this manner during the early planning phase of construction projects reduces uncertainty during the location determination, foundation design, and construction phases of a project. This in turn reduces delays, overspend, and unnecessary use of material resources (e.g. concrete) during construction.

A variety of techniques can be used to ascertain the properties of a target sub-surface volume. These include down-hole and cross-hole techniques whereby one or more boreholes are drilled and soil samples obtained from the borehole are analysed. Other geological entities such as ground water wells can also be studied. Geological data (referred to herein as geodata) can also be obtained through seismology, from climate measurement stations and through a variety of other similar geological entities and investigations. Such geological study typically yields a large amount of geodata from a variety of sensors and data sources. Processing and visualising such a large amount of geodata in a way that is both computationally efficient and intuitively understandable to an analyst is problematic, due to the volume of data and the fact that data often comes from many different locations and data sources.

There is a need to provide improved mechanisms for processing and visualising such geodata in a manner that is computationally efficient and facilitates easy and intuitive understanding of data and comparison between data arising from different geological entities and data sources. There is also a need to provide an intuitive, simple user interface for displaying and moving through the significant amount of geodata obtained, and for combining related geodata in a simple, user-friendly, and efficient manner.

### OVERVIEW

According to an aspect of the present disclosure, there is provided a computer-implemented method of associating geodata with a collection of display templates. “Geodata” in this context means geological data, in other words any form of data obtained through geological study pertaining to one or more properties of a sub-surface volume, particularly ground (e.g., soil, rock, water) characteristics. Geological data can be used in contexts such as borehole logs, well design, data sequence graphs and so on. The method comprises: receiving a selection of two or more display templates configured to graphically represent geodata; grouping the selected display templates into a display template collection; receiving a selection of a first database object comprising geodata; creating a connection between the display template collection and the first database object to enable the geodata to be retrieved from the first database object to the display template collection; and populating the display templates within the display template collection with the geodata retrieved from the first database object.

The disclosed method enables a variety of geodata associated with a particular database object to be easily retrieved and represented in a collection of display templates. The display templates can be configured to display different aspects of the geodata, as described more fully below. The user only needs to select the desired templates and database object, and the system automatically pulls the relevant geodata to populate the selected templates, all within the context of a single display template collection. There is no need to individually open and populate each display template separately. In previous methodologies, many different computer programs would need to have been used to display all the geodata appropriately. In the improved methodology disclosed herein, however, all geodata can be retrieved from a database object and displayed in a single computer program containing a collection of display templates. No complex programming is required at the use-stage to enable this functionality. Rather, the user can simply interact with the interface with simple inputs as described above and the system then seamlessly generates the connection between the database and the display templates behind the scenes to retrieve and display the relevant data. As explained in further detail below, the system can intelligently obtain different types of data and automatically represent these visually in the most appropriate and intuitively understandable way. This enables data objects to be easily compared, and trends and patterns that would otherwise not be apparent to be easily identified. Hence, a more computationally efficient mechanism for displaying geodata is provided (no need to open several programs, no need to interact individually with display templates, no need for any complex coding at use time) that is also more intuitive and provides an improved user-machine interface (only two simple selection inputs are required to retrieve geodata from the database to the display template collection).

The method may further comprise displaying one or more display templates of the display template collection. In other words, once the geodata has been retrieved and populated within the context of the display templates of the collection, the display templates can then be displayed, for example on a computer display for analysis.

Each display template in the display template collection may be configured to display a different type of geodata. For example, one display template may be configured to display geotechnical soil log data. Another display template may be configured to display soil unit weight by depth. Yet another display template may be configured to display soil water content by depth. Each of these three example display templates may be included in the same display template collection, such that when a relevant database object is selected the appropriate data from the database object is retrieved and used to populate the respective display templates. As a result, a rounded and complete geodata description of a geological entity to which the database object relates can be provided within a single display template collection and interface.

Accordingly, the method may further comprise populating a first display template in the display template collection with a first type of geodata from the first database object and populating a second display template in the display template collection with a second type of geodata from the first database object. As already noted, when used in this manner different display templates can aid in understanding different aspects and types of geodata associated with a geological entity or site. No complex coding is required by the user to enable this-they simply select the display templates and the database object(s) and the system then automatically retrieves the appropriate data to populate the selected display templates.

Populating the display templates within the display template collection with the retrieved geodata may comprise associating the retrieved geodata with one or more display objects comprised within the display templates. This can configure the display object(s) to present the geodata with which they are associated, as described more fully below. A display object may be considered an interface, an image, a “widget” or other any other suitable constituent of the display template which is provided to display geodata in a particular manner, or to display a particular type of geodata within the display template. Examples of display objects include schematic borehole diagrams, tables, and graphical plots. Each display template may comprise multiple display objects so as to display a variety of data types, or to display data in a variety of manners. Each geodata type may be automatically retrieved and displayed in an appropriate display object based on what display objects (e.g., borehole diagram, graphical plot etc.) are contained in a given display template.

The method may further comprise: receiving a selection of a second database object comprising geodata; creating a connection between the display template collection and the second database object to enable the geodata to be retrieved from the second database object; and populating the display templates within the display template collection with geodata from the second database object. In other words, a display template collection can be used to collate and display data from multiple database objects. This facilitates easy comparison between database objects. As explained more fully below, database objects may relate to a variety of geological entities. In one example, a first database object may be associated with a first borehole site, and a second database object may be associated with a second borehole site. The disclosed method enables data from both boreholes to be easily combined and compared within a single display template collection, which can be printed as a report as described more fully below.

The method may further comprise displaying retrieved geodata from the first database object and the second database object in the same display object. As a result, the disclosed system can facilitate easy comparison of data from different database objects-data from both can be shown in the same display object. For example, if the display object is a graphical plot, data from both data objects can be plotted on this same, single plot for easy comparison. An example of this is shown in more detail below.

The database object(s) of the present disclosure may be associated with respective geological entities. A “geological entity” can be considered as the physical instance or location from which geodata is obtained. Examples of geological entities include: a borehole, a groundwater well, a climate measurement station, a soil container, or a water container. In other words, database objects (and the geodata they contain) can relate to a variety of geological entities and locations.

The geodata may comprise data obtained from a plurality of data sources. Examples include borehole logs, general site data, soil sample data, pictures or diagrams of the geological entity, data sequences (such as those obtained through cone penetrometer test (CPT) experiments and similar), field and laboratory measurement data, well design data, and groundwater data.

The method may further comprise: receiving an instruction to refresh the connection between the display template collection and the first database object; in response to receiving the instruction, retrieving updated geodata from the first database object; and replacing the geodata populated within the display templates of the display template collection with the updated geodata. As a result, the displayed geodata can be easily updated using a simple refresh. This enables changes in the database to be quickly reflected in the display (or the printed report), via a single intuitive user input. No further coding is required to retrieve the updated data, improving the user-machine interface.

The method may further comprise: receiving an instruction to print a report comprising the display template collection; and printing the report, wherein the report comprises the geodata from the first database object (and optionally from other database objects) displayed within the display templates of the display template collection. Hence, the disclosed method and systems enable geodata to be seamlessly pulled from a database object, populated into a collection of appropriate geodata display templates and printed as a report. All of this can be achieved using only a small number of very simple user inputs, such as selection of the desired templates and database object. The report can be digital (e.g. a PDF document) or a physical printout.

According to another aspect of the present disclosure, there is provided a graphical user interface, GUI, configured to display geodata, comprising: a display template selection area comprising a display template collection, the display template collection comprising two or more display templates configured to graphically represent geodata; and a database object selection area comprising a list of database objects available for selection, wherein the GUI is configured such that, in response to selection of a database object from the list of database objects, geodata is retrieved from the selected database object and populated within the display templates of the display template collection. This provides a simple and intuitive user interface for the collation, combination, and eventual display of geodata. The user simply has to select a database object and display templates the data is automatically displayed within the selected collection of templates. No further programming is required, and there is no need to open multiple windows or programs to display different types of geodata or geodata from different sources.

According to another aspect of the present disclosure, there is provided a system comprising one or more processors and one or more memories having stored thereon computer-readable instructions configured to cause the one or more processors to perform any of the methods disclosed herein.

According to another aspect of the present disclosure, there is provided a computer-readable medium comprising instructions, that, when executed by one or more data processing apparatus, cause the one or more data processing apparatus to perform any of the methods disclosed herein.

According to another aspect of the present disclosure, there is provided a computer program comprising instructions which, when the program is executed by a computer, cause the computer to perform any of the methods disclosed herein.

### BRIEF DESCRIPTION OF THE DRAWINGS

Disclosed implementations will now be described by way of example to illustrate aspects of the disclosure and with reference to the accompanying drawings, in which:

FIG. 1 shows schematically a system that can be used to implement the disclosed methods;

FIG. 2 shows a method of visualising geodata according to the present disclosure;

FIGS. 3-6 demonstrate example implementations for configuring database objects of the present disclosure;

FIGS. 7-9 demonstrate example implementations for configuring display templates of the present disclosure;

FIGS. 10-14 demonstrate example implementations for using display templates of the present disclosure once they have been configured;

FIGS. 15-20 demonstrate example implementations for combining display templates of the present disclosure into display template collections; and

FIG. 21 shows a block diagram of a computing device which can be used to implement the disclosed methods.

### DETAILED DESCRIPTION

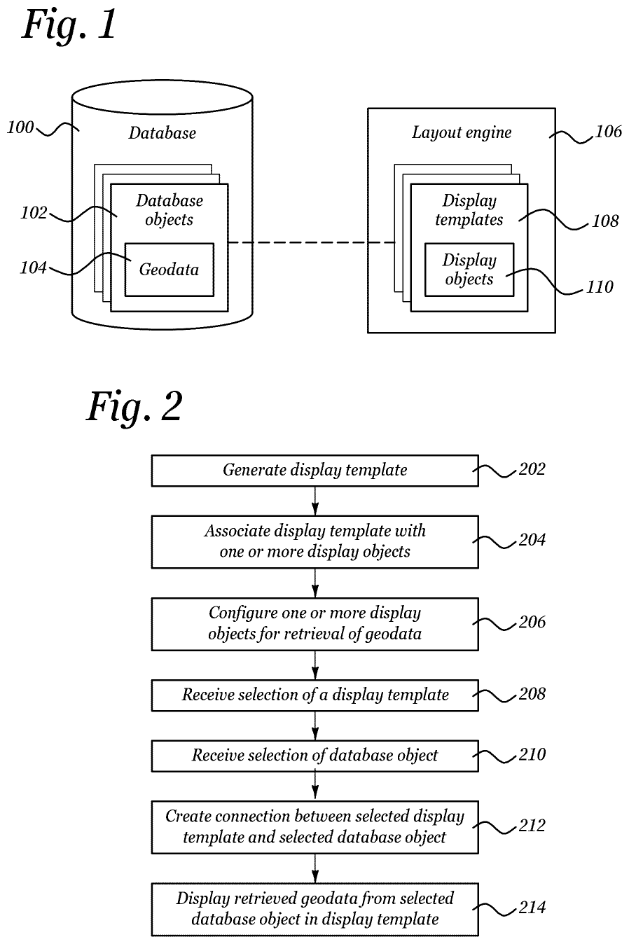

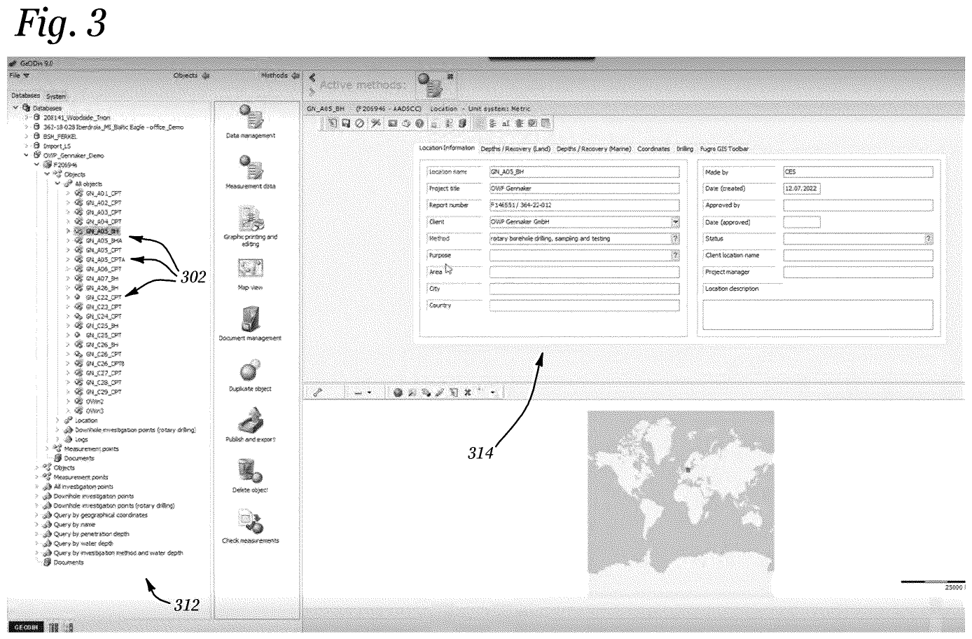

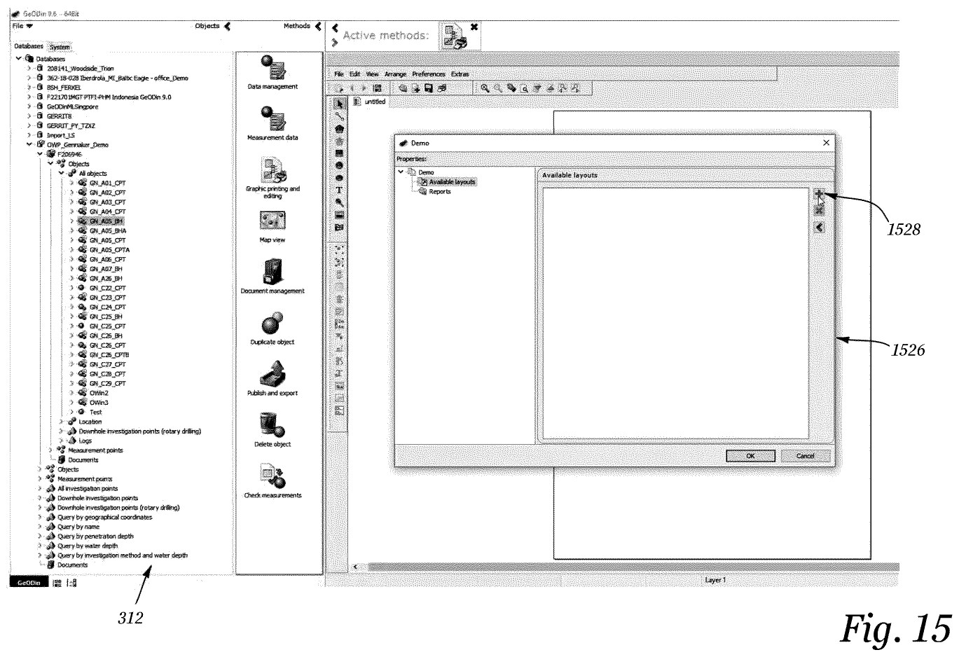

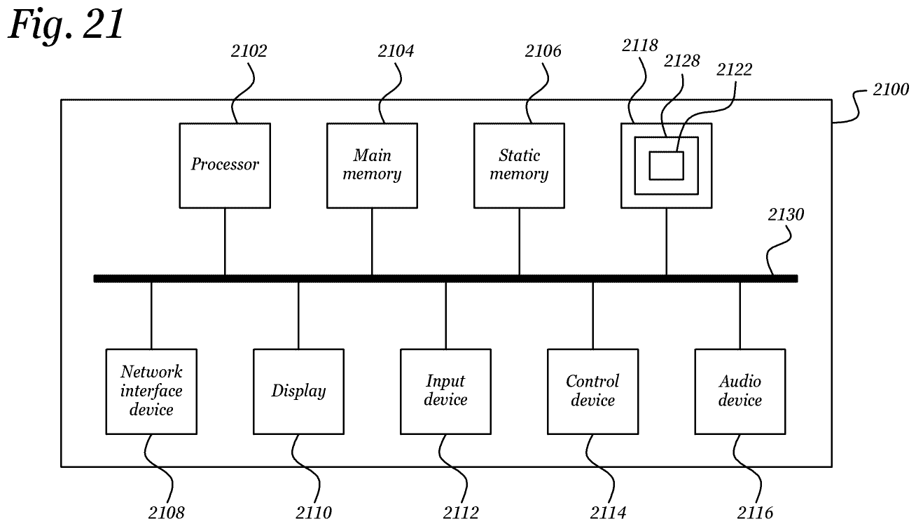

This detailed description describes, with reference to FIGS. 1 and 2, systems and methods for providing improved representation of geodata that provides a better user-machine interface and enables select data from a geodata database to be quickly and efficiently obtained and displayed, without requiring any programming or the opening of multiple programs or display windows. Example implementations showing how the disclosed systems and methods can be used to configure database objects, configure templates, and finally use the configured display templates are shown with reference to FIGS. 3-14. Combination of display templates into display template collections, which facilitates easy visualisation and reporting of larger geodata projects, is described with reference to FIGS. 15-20. Finally, a computing device that may be used to perform the disclosed methods is described with reference to FIG. 21.

The methods and systems disclosed herein relate generally to representing geodata visually using display templates and may be considered as relating to two-dimensional computer aided design (2D CAD). Through appropriate configuration, the display templates of the present disclosure can be configured to automatically retrieve geodata from a database and display or visualise the geodata in an appropriate manner or in a manner which facilitates streamlined and effective analysis thereof and enables patterns, trends, and anomalies to be easily identified. Display templates can then be grouped into display template collections to enable a variety of geodata to be easily combined, visualised, and reported. The disclosed systems and methods address problems with existing geodata display systems, which do not provide a single, unified display that can be used to display and report a variety of types of geodata in a single interface. Typically, in existing systems, a variety of programs needed to be used to display the various types of data. Often, a degree of programming was required at use time from the end user in order to ensure the correct geodata was obtained and displayed. There was previously no single, unified system that was capable of retrieving and displaying geodata from a variety of sources in an efficient and intuitive manner based on only very basic user inputs. The disclosed systems and methods address these deficiencies and provide an improved geodata display system.

Turning first to FIG. 1, a system that can be used to implement the disclosed methods is shown schematically. A database 100 is shown containing a plurality of database objects 102. A database object in the context of the present disclosure can be considered as a set or bundle of geodata 104 associated with a particular geological entity, geological test or geological experiment. The set of geodata 104 in each database object 102 may comprise data obtained from a plurality of data sources. For example, a particular example database object 102 may comprise a variety of geodata 104 relevant to a particular borehole. This borehole geodata may comprise data obtained through a variety of means and from a number of sources, such as data obtained using a cone penetrometer test (CPT), data from lab or field-based experiments on soil samples taken from the borehole, seismology data obtained from or around the borehole, or data from any other suitable sensor or measuring device associated with the borehole in question. All this geodata for the given borehole can then be grouped as a database object 102 and stored within database 100. Other database objects 102 will similarly contain sets of geodata 104 associated with different respective geological entities. Geological entities may include boreholes, groundwater wells, climate measurement stations, soil containers, water containers or any other suitable entity, geological site or test from which geological data can be obtained. Geodata 104 may accordingly contain any suitable data obtainable from such geological entities, including but not limited to borehole logs, general geological site data, soil sample data, pictures of the geological entity, data sequences (such as obtained through a CPT experiment), field and laboratory measurement data, well design data, groundwater data and so on.

Also shown in FIG. 1 is a layout engine 106. This layout engine is configured to implement the methods disclosed herein, in order to display geodata 104 from database objects 102 visually, for example via a display or graphical user interface. Layout engine 106 comprises a plurality of display templates 108 which can be configured to display different types of geodata 104 in various manners. Display templates 108, which may also be referred to as “display layouts” or simply “layouts”, comprise display objects 110 which are the elements actually used to display the geodata 104 visually. For example, display objects 110 may comprise schematic diagrams (e.g., of the geological entity from which the geodata 104 being displayed arises), tables, graphical plots and any other suitable schematic representation, plot or diagram suitable for displaying geodata 104.

Display objects 110 may be configured to display the same geodata in a different manner. For example, one display object 110 may display water content of soil as a graph whereas another display object 110 may display the same water content data as a table. By displaying the same data in different manners, understanding can be improved because data is shown in a variety of manners, from each of which certain insights may be made more apparent. Alternatively or additionally, display objects 110 may display different types of data. For example, one display object 110 may display water content data and another display object 110 may display soil composition data. By having two display objects displaying this data side by side, the data can be easily compared and patterns, trends and correlations that were not previously apparent may become identifiable. For example, the correlation between soil water content and soil composition or soil depth may be more readily apparent.

The layout engine 106 is configured to retrieve geodata 104 from database objects 102 in database 100. The retrieved geodata 104 can then be displayed in the one or more display objects 110 as described above. Put another way, the layout engine 106 is configured, responsive to user input, to create a connection between one or more particular display templates 108 that are in use and one or more database objects 102 to enable the geodata 104 to be retrieved from the database object(s) 102 and displayed in the display template(s) 108 (for example using one or more display objects 110). This connection can be created responsive to receiving a user selection of a particular display template 108 or group of templated and a corresponding selection of a database object(s) 102. The connection is shown schematically in FIG. 1 by way of a dashed line connecting the database object(s) 102 and the display template(s) 108.

Retrieval of the geodata 104 from display object 102 for display in one or more display templates 108 can be achieved in a variety of ways, the details of which will be apparent to a skilled reader. Merely as one example, creating the connection between a display template 108 or set of templates and a database object 102 can comprise populating a macro function embedded within the display template(s) 108 with an address of the relevant database object 102, responsive to selection of that database object 102. This macro can then enable geodata 104 to be retrieved (also referred to as being “pulled” or “called”) from the database object 102. Other mechanisms by which the geodata 104 can be retrieved from the database object 102 following selection of that database object 102 will be apparent to a skilled reader and can be used in the context of the present disclosure.

Retrieval of the geodata 104 is typically an instantaneous process, in that the geodata 104 obtained reflects the state of the geodata 104 in the database object 102 at the time at which the connection between the database object 102 and the display template(s) 108 was formed. The connection and the displayed data can be updated, for example in response to a “refresh” input from a user. In response to receiving an instruction to refresh the connection between the display template and the first database object, the layout engine 106 may be configured to retrieve updated geodata 104 from the respective database object 102 to which the connection was previously formed. The layout engine 106 can then replace the geodata 104 previously displayed in the display template(s) 108 with the updated geodata 104. This enables the display to accurately reflect any changes to the geodata 104 that have been made since the connection was initially established.

The layout engine 106 can be configured to establish a connection between one or more display templates 108 and a plurality of database objects 102. For example, layout engine 106 may receive or detect selection of first and second database objects 102 and, in response, create a connection between selected display template(s) 108 and both the first and second database objects 102 to enable the geodata 104 from both database objects 102 to be retrieved and displayed alongside one another. This functionality enables geodata 104 associated with a plurality of geological entities to be displayed in a single display template 108 or within multiple display templates 108 within a single display template collection, as described more fully below. This can facilitate comparison and enable trends, patterns and insights to be spotted that were previously not apparent. For example, displaying geodata from a borehole next to laboratory data from a sample may yield insights into the soil behaviour. Exemplarily, by combining geodata from a borehole, data sequences from a cone penetration test, and laboratory measurement data from soil and rock samples, it is possible to obtain deep conclusions of the potential soil behaviour. The geodata 104 from the two (or more) database objects 102 may be displayed within a display template 108 in a single display object 110 (for example on a single graphical plot or schematic representation) or in multiple corresponding display objects 110. Where the geodata 104 is displayed in a single display object 110, a different visual style or formatting may be used to distinguish geodata 104 from a first database object 102 from geodata 104 from another database object 102.

Where a display template 108 comprises a variety of display objects 110 configured to display different types of geodata 104, the layout engine 106 can be configured to automatically retrieve the appropriate type of geodata 104 from the selected database object 102. This means that the user does not need to specify the type of data that is required; rather, the type of data required by a particular display object 110 is embedded in the display object 110 (for example within metadata) such that the layout engine 106 automatically knows what type of geodata 104 to look for in database object 102. This improves ease of data retrieval and display and means no coding is required at the use-stage, even when a variety of display objects 110, each configured to display a different type of data or display data in a different manner, is used.

The layout engine 106 may be configured to print a report comprising the geodata 104 displayed in the display template(s) 108. The report can be printed in a digital form (for example as a PDF document) or as a physical report by sending an appropriate instruction to a printer.

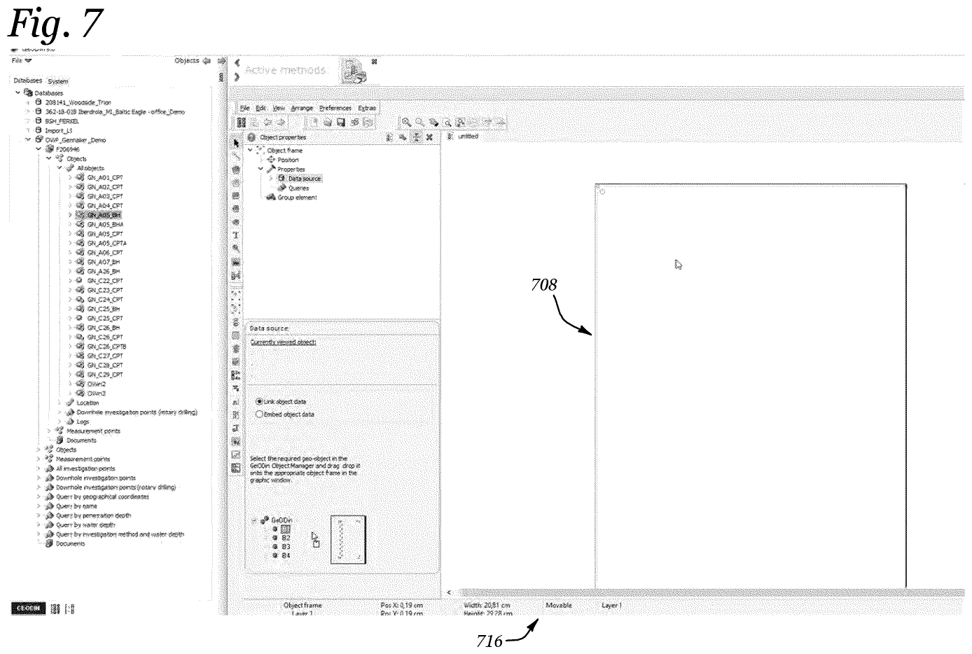

Prior to display of geodata 104, the layout engine 106 may enable creation and configuration of the display template(s) 108 used to display the geodata 104. Configuration of each display template 108 may comprise generating the display template 108, associating the display template with one or more display objects 110 configured to display geodata, and configuring the one or more display objects such that, in response to selection of one or more database objects 102 comprising geodata, geodata 104 is retrieved from the one or more database objects 102 and is displayed in the one or more display objects 110. An example of this process is described in further detail below in relation to FIGS. 7-9. As noted above, the step of configuring the display template(s) 108 and display object(s) 110 such that they retrieve geodata 104 in response to user selection of a database object 102 can be performed in a variety of ways, for example using macros.

The layout engine 106 may provide a suitable graphical user interface, GUI, configured to effectively display geodata. Example GUIs which can be provided are shown in the examples described in more detail below. At a high level, the GUI may comprise a geodata display area comprising a display template (e.g., one of display templates 108) configured to graphically represent geodata (e.g., geodata 104). The GUI may also comprise a database object selection area comprising a list of database objects (e.g., database objects 102) available for selection. The GUI may be configured such that, in response to selection of a database object from the list of database objects, geodata (e.g., geodata 104) is retrieved from the selected database object and displayed in the display template in the manner described above.

In one advantageous example, the GUI comprises a first display object 110 configured to display a first type of geodata 104 and a second display object 110 configured to display a second type of geodata 104. The GUI may then be configured such that, in response to selection of the database object 102 from the list of database objects, the first type of geodata 104 is retrieved from the selected database object 102 and displayed in the first display object 110 and the second type of geodata 104 is retrieved from the selected database object 102 and displayed in the second display object 110.

Turning now to FIG. 2, a method is shown schematically. The method, which is computer-implemented, may be performed by the layout engine 106 described above. Steps 202-206 relate to generating and configuring display templates (such as display templates 108 discussed above in relation to FIG. 1) for use in the systems of the present disclosure. These steps may therefore be considered to represent a configuration or setup phase. Steps 208-214 then relate to use of the display templates and may thus be considered to represent a use or implementation phase. Steps 202-206 can be performed at a separate time, in a separate location and/or by different users and computing systems to steps 208-214. For example, a set of display templates may be generated by one party and then provided to a second party for use. Hence, the method of FIG. 2 may more accurately be considered as two separate and independent methods, which can optionally and in some cases be combined.

Turning now to the details of the method, at step 202 a display template is generated. The display template is configured to graphically represent geodata (e.g., geodata 104 described above) and can have the properties described above in relation to display templates 108. At step 204, the display template is associated with one or more display objects. These display objects are configured to display geodata within the display template and can have the properties described above in reference to display objects 110. Association of display objects with the display template can be performed in any suitable manner. In one particularly intuitive example, display objects can be associated with the template through “drag-and-drop” functionality, whereby a user clicks on a display object and, without releasing the mouse button, drags the display object onto the display template before releasing the mouse button. As noted above, display objects may comprise schematic diagrams, graphical plots, tables and any other visual component suitable for displaying geodata.

The method may then comprise, at step 206, configuring the one or more display objects such that, in response to selection of one or more database objects comprising geodata, geodata is retrieved from the one or more database objects and is displayed in the one or more display objects. As noted above, in one example step 206 can involve incorporating or embedding a macro within each display object 110 or within the display template as a whole, wherein the macro configures the display object 110 (or template as a whole) to retrieve or pull data from a data source once a source has been identified. In practice, identification of the data source can be performed by detecting a user selection of a database object, such as one of database objects 102, as described above.

With the display template configured in this manner, the template is now ready for use and the configuration phase is complete.

The use phase begins at step 208, whereby a selection of a display template is received. This selection can be in any suitable form and is typically provided by a user clicking or otherwise selecting a display template from a list of available display templates. In one example, a display template may be selected using a drag-and-drop input, whereby the selected display template is dragged into an available display template area of the user interface. At step 210, selection of database object is received. This selection input can again involve any suitable form and is typically provided by a user clicking or otherwise selecting a database object from a list of available database object. In one particularly intuitive arrangement, step 210 involves a user dragging and dropping a database object from a list of available database objects into a template that is open on screen. Once a database object has been selected, a connection is created between the selected display template and the selected database object. This connection enables geodata (such as geodata 104 described above) to be retrieved from the selected database object and displayed in the display template as described above, for example in the one or more display objects contained within the display template. As noted above, this connection can be implemented in some examples by populating a macro embedded within the display template. Once a user selects a database object, the macro is populated with the address or database location of the selected database object, such that geodata can be retrieved therefrom to populate the display objects of the display template. Finally, at step 214 retrieved geodata from the selected database object is displayed in the display template.

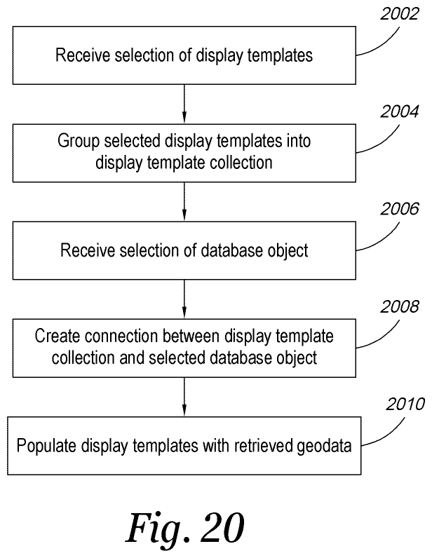

As can be seen, the disclosed method provides a simple and intuitive way for display templates to be both configured and used for displaying geodata. Both the setup and use phases require only basic user inputs such as clicking and drag-and-drop. No coding or other complex inputs are required, simplifying the process, and reducing the likelihood of errors. Geodata from multiple sources and associated with multiple geological entities can be easily and intuitively displayed together in a single program and display interface. A related method for grouping multiple display templates 108 into a display template collection is described below with reference to FIG. 20.

In order to further aid in understanding of the disclosed methods and systems, the above-described functionality will now be showcased in the context of real-world applications wherein the disclosed systems and methods are utilised to configure geodata objects, configure display templates and finally to visualise and display geodata in a variety of ways. This functionality will now be explained with reference to FIGS. 3-19. FIGS. 3-19 show photographs (screenshots) of a graphical user interface used to implement the disclosed functionality. It will be appreciated that these screenshots are provided with the sole purpose of schematically demonstrating the underlying functionality provided by the systems and methods of the present disclosures. The actual substantive content (text, numbers etc.) of these particular screenshots is not fundamental to understanding the disclosed invention, is non-limiting and will of course change as different geodata is analysed in different real-world contexts. Hence, FIGS. 3-19 should be considered as schematic diagrams exemplifying the disclosed functionality, rather than there being any fundamental importance in the actual data displayed in these specific screenshots. The disclosed functionality is also not limited to use in the shown software but can be implemented using any suitable software.

Turning first to FIGS. 3-6, these figures show how database objects (such as database objects 102 described in reference to FIG. 1) can be configured.

FIG. 3 shows an example user interface panel that may be used to implement some of the disclosed methods. On the left hand side, a database object selection panel 312 (alternatively referred to as a database object selection area) is shown containing list of database objects 302 stored in a database. These database objects 302 are equivalent to database objects 102 described above with reference to FIG. 1. One of the database objects 302 is selected, relating to a borehole log. This database object is denoted GN_A05_BH. A database object configuration panel 314 is shown, comprising a number of data fields in which geodata for the selected database object can be entered, viewed and modified. This data can comprise identification data, location data and geodata of the sort described above with reference to geodata 104.

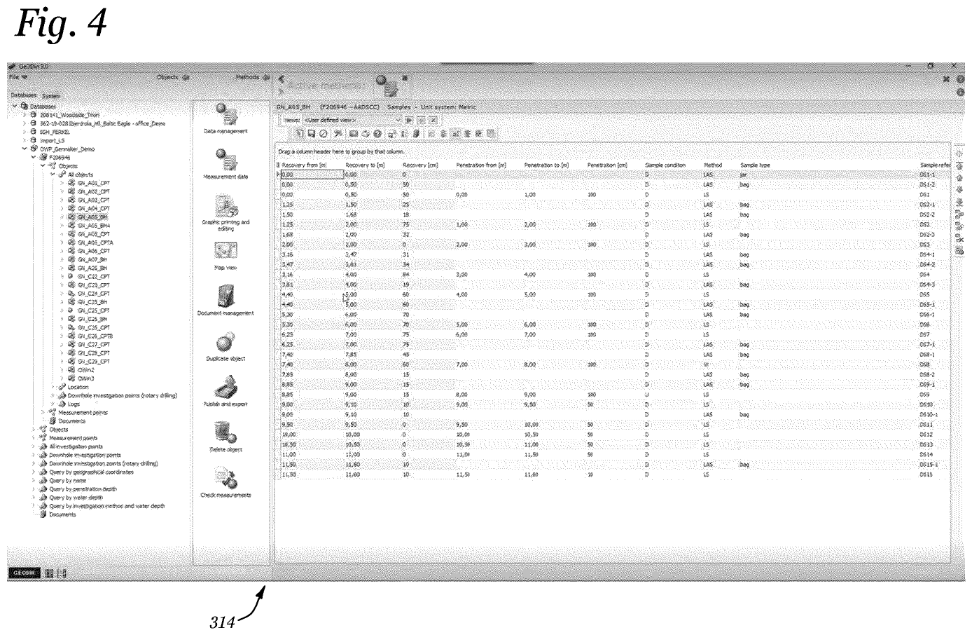

FIG. 4 shows another display tab which can be displayed in database object configuration panel 314 and used to populate the database object with geodata. In this example, borehole layer geodata is shown, providing soil descriptions for different layers of soil corresponding to a plurality of samples obtained from borehole GN_A05 during a soil survey.

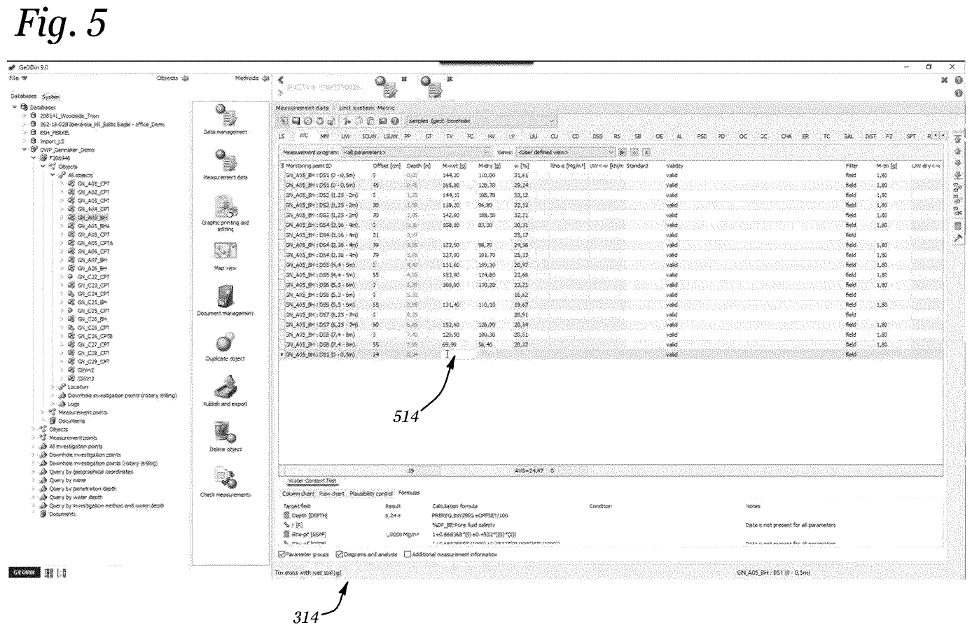

FIG. 5 shows yet another screen which can be displayed in database object configuration panel 314 and used to populate the database object with geodata. In this screen, detailed geodata for soil samples associated with the borehole is provided, including data relating to the depth at which each sample was taken, the wet soil mass of the sample, the dry soil mass of the sample, the moisture content of the sample and other relevant parameters. Note that a user is in the process of adding a new entry of sample data 514 at the bottom of the list of samples. Data can be added manually in this way or populated automatically, for example based on received sensor data.

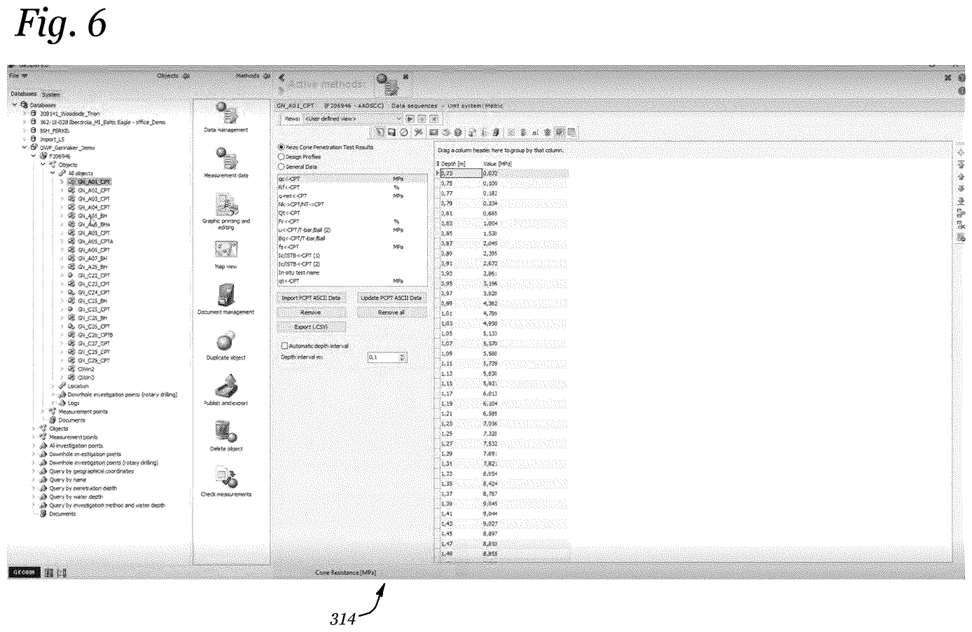

FIG. 6 again shows the database object configuration panel 314, but now a different database object is selected in the left hand object selection panel 312. In particular, now the database object 302 selected relates to CPT test A01, denotes GC_A01_CPT. Accordingly, the fields shown in database object configuration panel 314 now include fields that can be populated with geodata from a CPT test, in this example soil pressure data obtained at a plurality of soil depths. It will be appreciated that, depending on the type of database object 302 selected, the database object configuration panel 314 will contain different appropriate fields to record the associated geodata.

Turning now to FIGS. 7-9, these figures show how display templates (such as display templates 108 described in reference to FIG. 1) can be configured. Accordingly, FIGS. 7-9 show examples of how the steps 202-206 of FIG. 2 described above may be implemented.

Turning first to FIG. 7, a template configuration panel 716 is shown which can be used to configure a display template. A blank display template 708, which corresponds to the display templates 108 of FIG. 1, is shown.

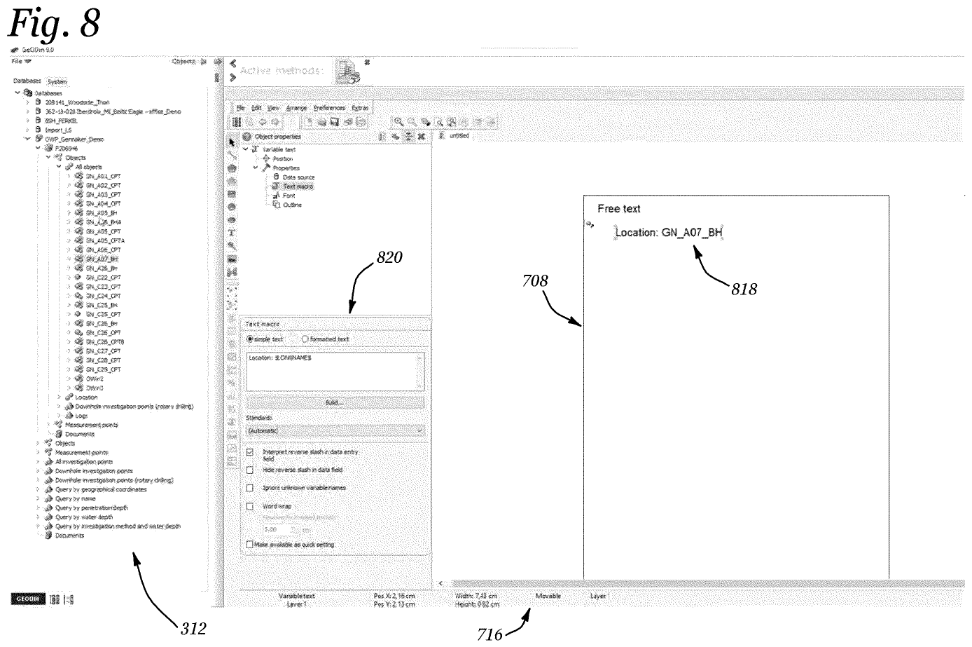

In FIG. 8, a variable text display object 818 has been embedded within display template 708 and incorporates a macro that has been defined using macro configuration panel 820. In this example, embedding of the variable text object 818 containing the macro within the display template 708 enables the display template to call a database object location in order to retrieve or pull geodata from that database object. In the example shown, selection of database object GN_A07_BH from database object selection panel 312 has resulted in the embedded variable text macro 818 being populated with the name of that database object. This instructs the display template 708 to retrieve and populate any display objects contained within display template 708 with geodata from database object GN_A07_BH.

Note that the macro embedded in variable text object 818 will update if a different database object is selected. For example, if database object GN_A05_BH were selected (by, for example, a drag-and-drop input of that database object into the display template 708), then the macro would automatically update such that the display template 708 pulls data from database object GN_A05_BH rather than database object GN_A07_BH. The only input from the user required to make this change is selection of the new database object-no programming is required because the macro is configured to automatically update and pull data from the most recently selected database object.

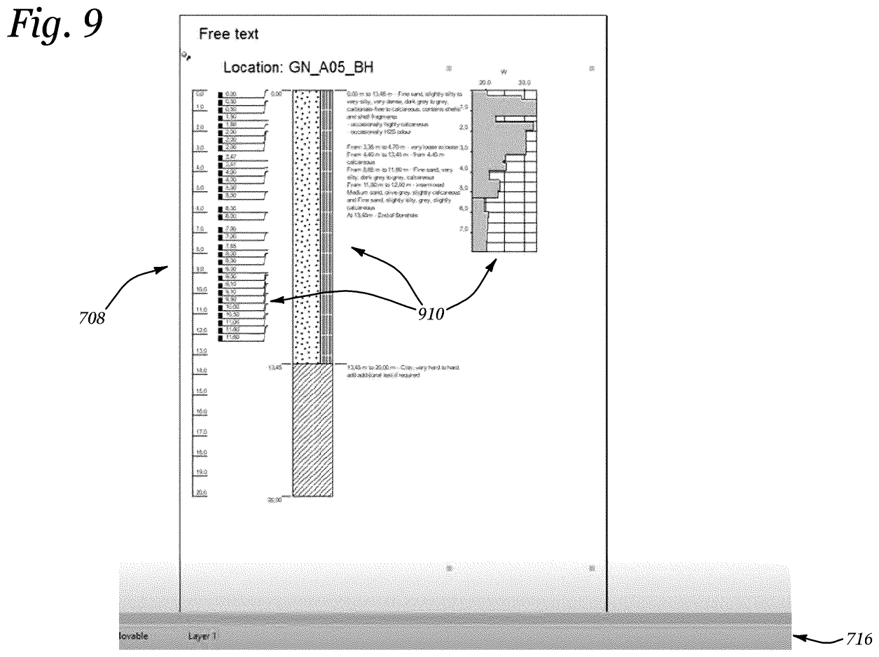

FIG. 9 shows a closeup of template configuration panel 716. The display template 708 is now shown containing a number of display objects 910, which correspond to and have the properties described above in reference to display objects 110. In the example shown, the display objects 910 include (from left to right) sample data, a lithological description alongside an associated schematic diagram of a borehole, and a data sequence showing sample moisture content in graphical format. Additional display objects 910 can be easily added to the display template 708 by a simple drag-and-drop input or similar selection and will automatically retrieve data from the same database object by virtue of the embedded macro described above. A depth scale is also shown at the far left hand side of the display template 708.

As noted, each of the display objects 910 automatically retrieves and displays geodata from database object GN_A05_BH, because this is the database object from which the display template 708 is currently configured to retrieve data (in this case by virtue of the macro embedded within variable text object 818). However, if a different database object (for example GN_A07_BH) were selected, the display objects 910 would automatically update to show data from GN_A07_BH instead (or in addition, if the template 708 is in multi-object mode-more on this below). This is achieved without any further input required from the user beyond selection of the new database object. This functionality is made possible because the embedded macro automatically retrieves data from whatever database object has been most recently selected, as noted above.

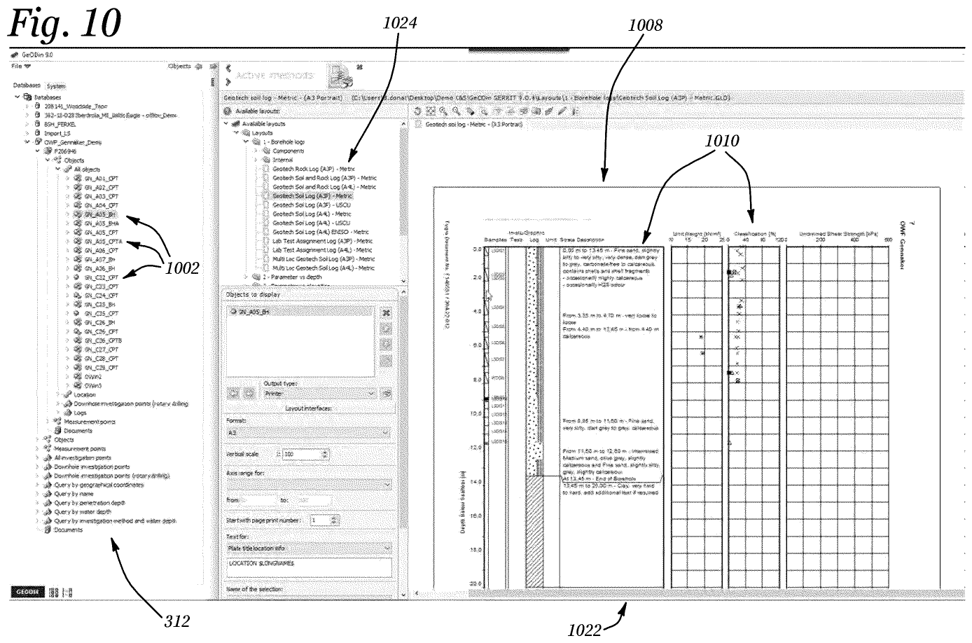

Turning now to FIGS. 10-14, these figures show how display templates (such as display templates 108 and 708 described above) can be used. Accordingly, FIGS. 10-14 show examples of how the steps 208-214 of FIG. 2 described above may be implemented.

Turning first to FIG. 10, a geodata display panel (also referred to as a geodata display area) 1022 is shown. A display template 1008 (equivalent to display templates 108 and 708 above) has been chosen from display template selection panel 1024 and is shown within geodata display panel 1022. Display template 1008 has previously been configured as described above with reference to steps 202-206 of FIG. 2 and in reference to FIGS. 7-9. Accordingly, upon selection of database object GN_A05_BH from the list of available database objects 1002, display template 1008 (or, more specifically, the various display objects 1010 contained therein) are automatically populated with geodata from database object GN_A05_BH. This can be seen in FIG. 10, where lithographic, unit weight and classification data is shown at different depths for soil samples associated with borehole GN A05.

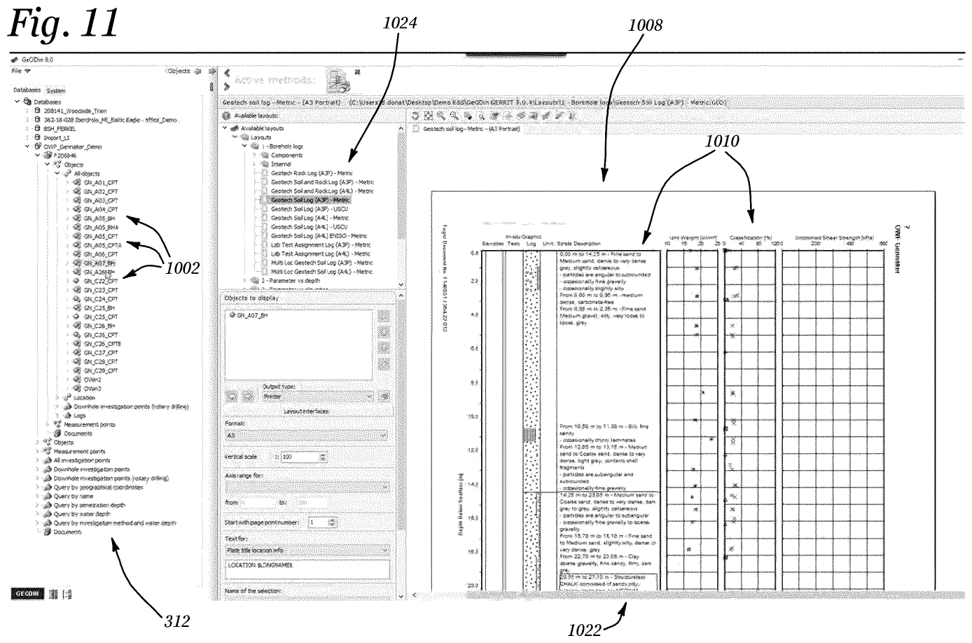

FIG. 11 shows the same display as FIG. 10, except now a different database object 1002 has been selected, namely GN_A07_BH. As a result, the display objects 1010 automatically update to show geodata from database object GN_A07_BH instead of GN_A05_BH. As noted above, selection of the new database object can be through a simple input, such as a click or a drag-and-drop input.

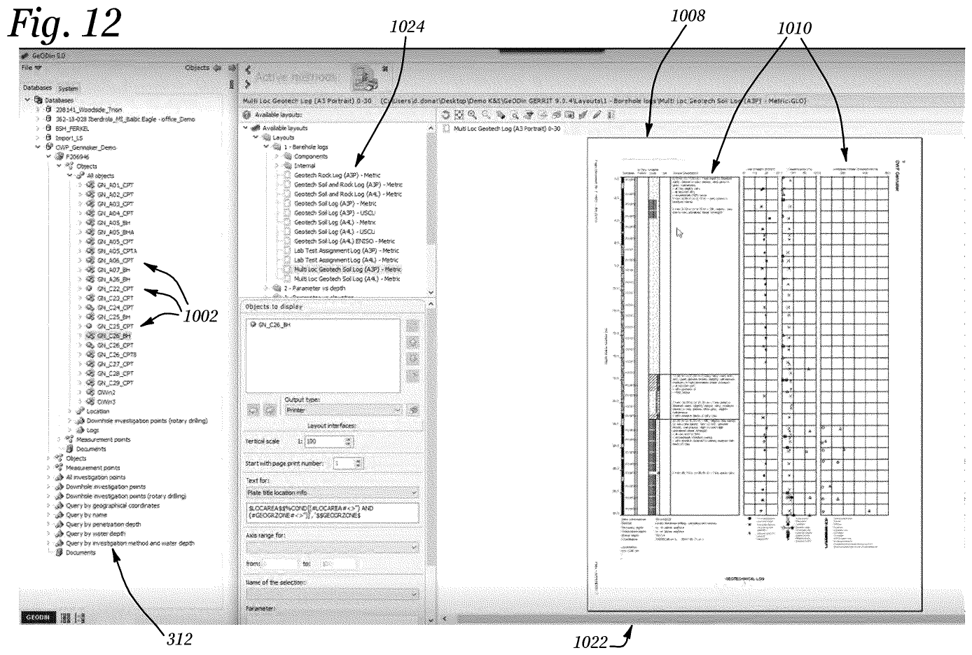

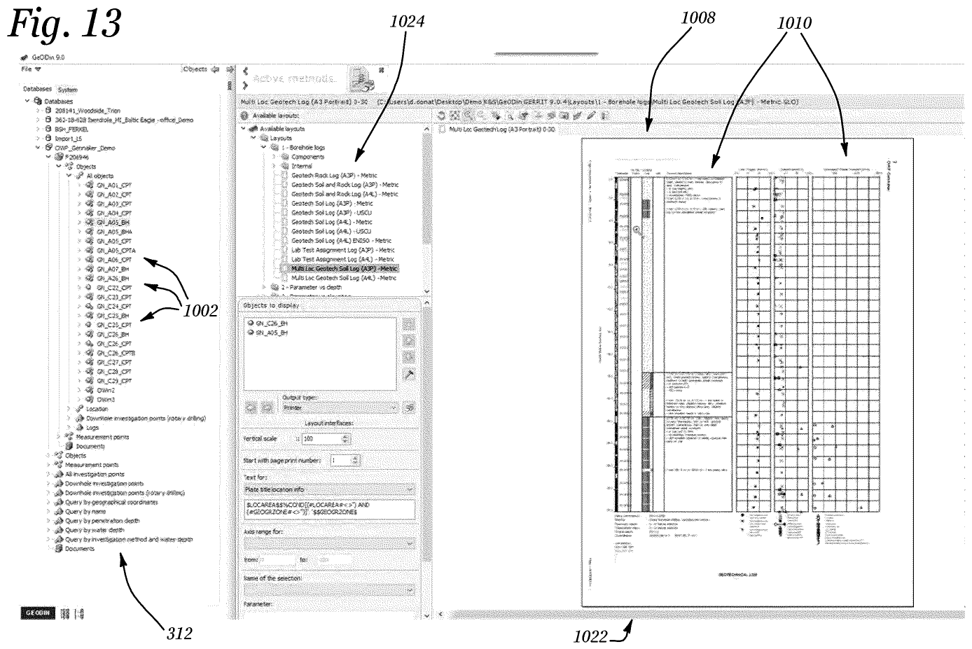

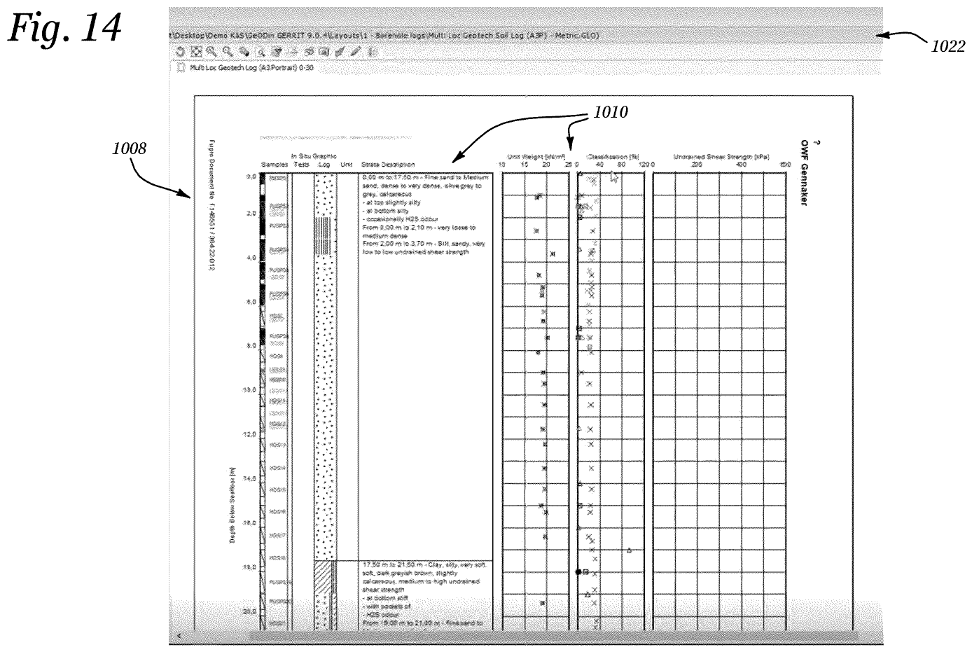

FIG. 12 shows the same display again, with yet another different database object 1002 selected, namely GN_C26_BH. The display template 1008 has in this example also been put into multi-object mode, meaning that selection of a new database object 1002 will cause the geodata from the new database object to be displayed alongside, rather than in place of, the current geodata from GN_C26_BH. This functionality is shown in FIG. 13, where both GN_C26_BH and GN_A05_BH have been selected from the database object selection panel 312. As a result, and because the display template 1008 is in multi-object mode, the database objects 1010 display data retrieved from both database objects alongside one another. To facilitate easy comparison, the geodata from GN_C26_BH is shown in a different format than that of GN_A05_BH, for example using a different colour or visual marker. This is shown more clearly in FIG. 14, which shows the display template 1008 and display objects 1010 in closeup-it can be seen that the data from GN_C26_BH uses a different colour (black) to the data from GN_A05_BH (light grey). It will be appreciated that any other suitable formatting can be used to distinguish the data from different database objects.

In the above description, display templates 108, 708, 1008 have been generally described as entities that are configured and displayed individually. However, it will be appreciated that for larger and more complex geodata projects, it may be desirable to retrieve a variety of types of geodata and display that geodata in a corresponding variety of display templates. The systems and methods of the present disclosure facilitate this functionality in an intuitive and efficient mechanism which avoids the need to individually connect separate templates to the database and instead allows display templates to be grouped and treated as a single collection of templates. The collection as a whole can then be populated with geodata in a single configuration step, and only one connection with a database object (or objects) needs to be established. This functionality will now be described with reference to FIGS. 15-20.

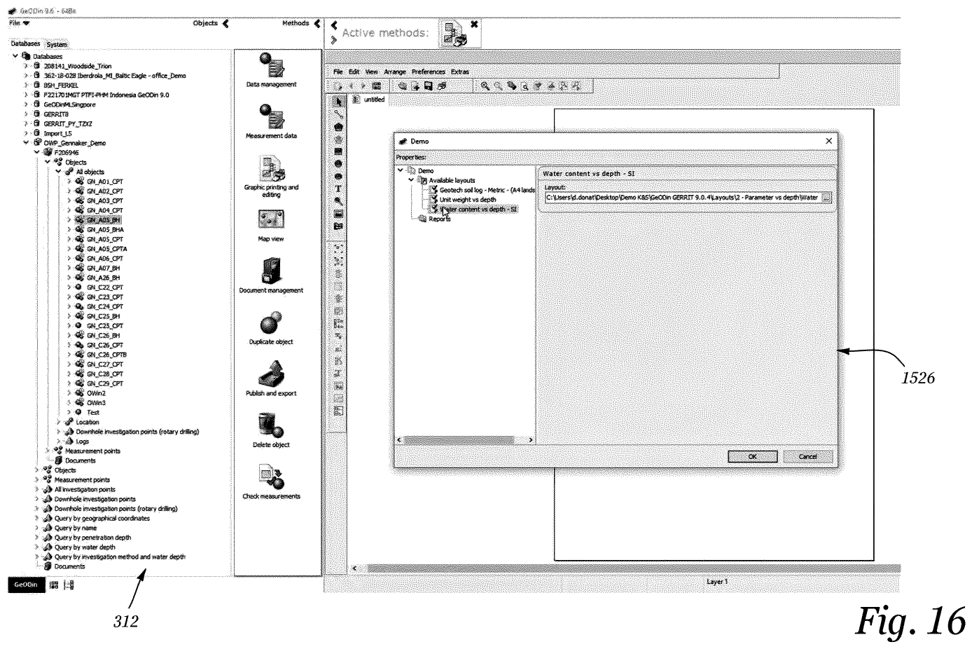

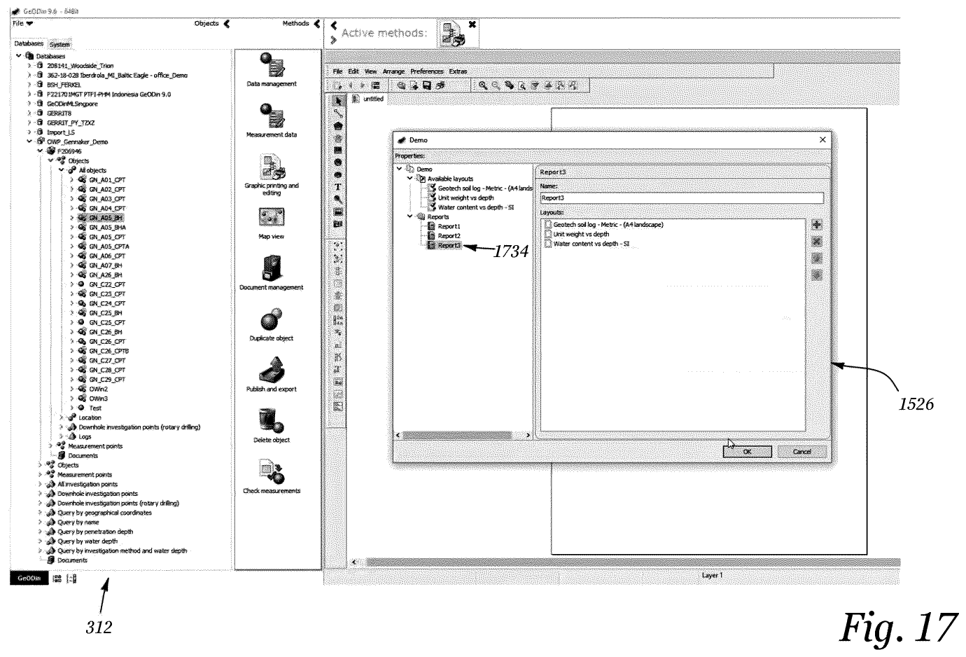

Turning first to FIG. 15, database object selection panel 312 is once again shown on the left hand side of the user interface. Now, however, the right hand area shows a display template selection panel 1526 (also referred to as a display template selection area) which can be used to select and group a plurality of display templates for displaying geodata. In other words, this panel can be used to define a display template collection. In this example, button 1528 enables a user to “add” a display template (for example one of display templates 108, 708 or 1008 described above) to the collection through a simple “click”, which then brings up a list of available templates or enables a user to navigate to a location in memory where the available display templates are stored. Other similar input mechanisms can be used, such as drag-and-drop, ensuring that the user interface is simple and intuitive. Turning to FIG. 16, three display templates have been selected for use in creating a display template collection. In this example, the three selected templates includes a geotechnical soil log template, a unit weight vs depth template, and a water content vs depth template. Each of these selected templates will typically have been previously configured as described above with reference to FIGS. 7-9. Each display template in this example is configured to display a different respective type of geodata obtained from a geological entity such as a borehole. FIG. 17 shows the three selected display templates combined into a display template collection 1734. By virtue of being grouped into a display template collection 1734, the display templates are now linked and are effectively treated by the program as a single object in terms of retrieving geodata. The display template collection 1734 is now ready to be linked to a database object.

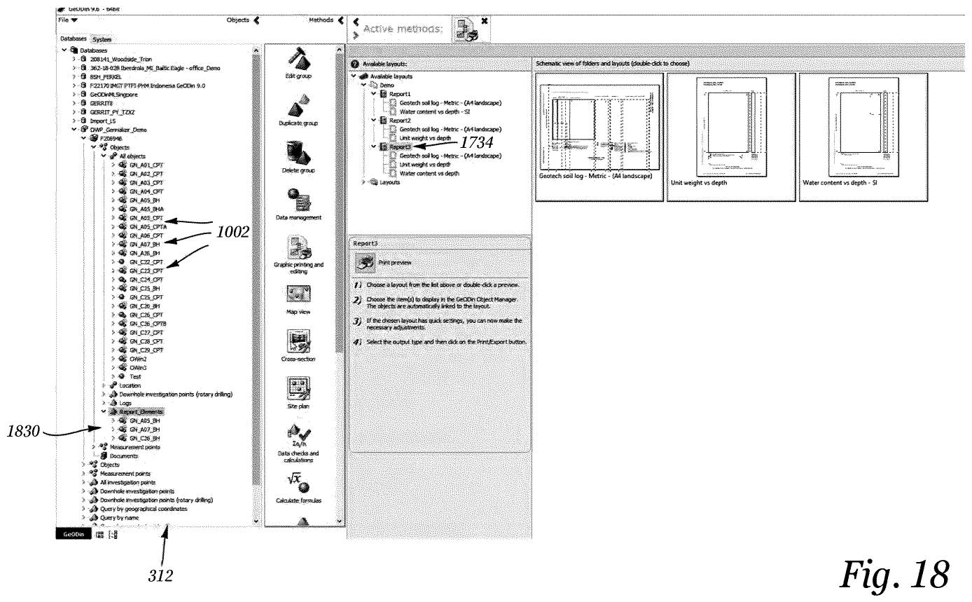

Turning to FIG. 18, three database objects have now been selected (via a simple click or drag-and-drop input) from the available database objects 1002 listed in database object selection panel 312. In the example shown, the three selected database objects 1002 have been placed in a database object group 1830 for ease of reference. Through a single user input, the group of database objects 1830 can now be instantaneously connected with the previously created display template collection 1734. In one example, this input may comprise clicking on a “print” button within the program, however any suitable input can be provided. In response to this input, a connection between the display template collection 1734 and the selected database objects (in this case the three database objects in database object group 1830) is formed. This connection enables the geodata to be retrieved from the selected database objects for display within the display templates of the display template collection 1734. The system is configured to automatically retrieve geodata that is appropriate to a respective display template. For example, if the display template collection includes a water content vs depth display template, then water content data will be retrieved from the selected database objects and provided to the respective display template for display.

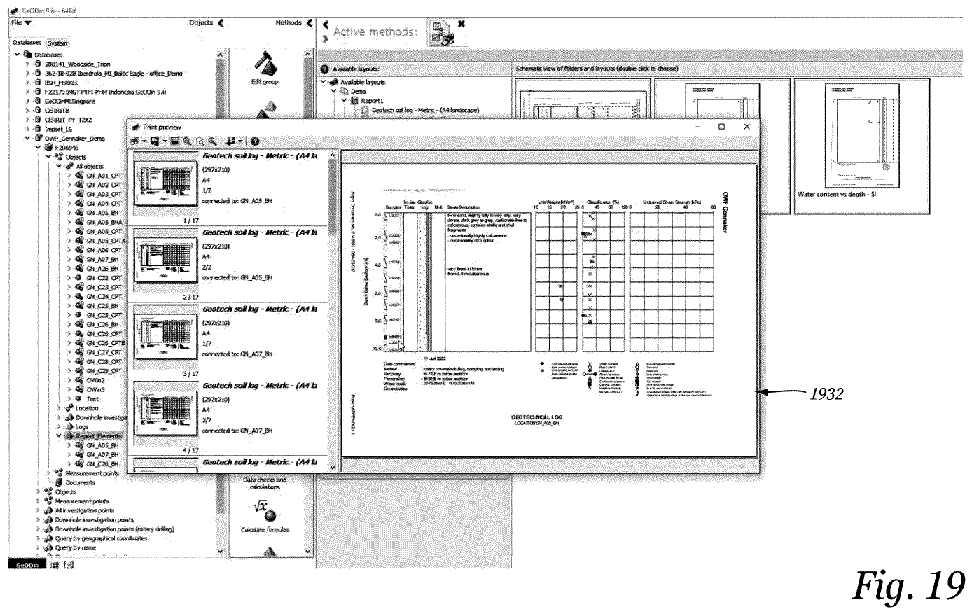

Once the connection between the display template collection 1734 and the database objects has been created, the display templates in the collection are automatically populated with the appropriate data retrieved from the display objects. The display templates of the collection can then be displayed, individually or as a group, and printed to a report (e.g., a digital PDF or a physical printout). FIG. 19 shows an example report 1932, comprising the three selected display templates chosen in the example of FIG. 16, now populated with geodata from the database objects of database object group 1830. Importantly, geodata from all three database objects in group 1830 is shown in a variety of display templates, each containing different respective display objects. All of this functionality has been achieved using only simple user inputs. Because the display template collection 1734 enables a group of display templates to be effectively treated as a single object, geodata can be pulled to each display template in the collection easily and without needing to configure each template separately. This significantly speeds up the process of creating a report for a database object or group of database objects, and there is no need to open multiple windows or programs. The entire collection can be generated and relevant geodata obtained through a single, streamlined user interface.

Turning to FIG. 20, a method is shown schematically. The method, which is computer-implemented, may be performed by the layout engine 106 described above. The method may be used to provide the functionality just described with reference to FIGS. 15-19. The method of FIG. 20 may be an addition or sub-process of the method of FIG. 2.

At step 2002, the method comprises receiving a selection of two or more display templates configured to graphically represent geodata. An example of this functionality was described above in relation to FIG. 16. The display templates may be display templates configured as described above in relation to FIGS. 7-9. At step 2004, the method comprises grouping the selected display templates into a display template collection. An example of this functionality was described above in relation to FIG. 17. Grouping the display templates into a collection enables the program to treat the display templates as a single object, to which a single connection with one or more database objects can be formed.

At step 2006, the method comprises receiving a selection of one or more database objects comprising geodata. In the above example of FIG. 18, three database objects were selected and formed into a group. However, it will be appreciated that any number of database objects may be selected, for example from database object selection panel 312. The database objects may be configured as described above with respect to FIGS. 3-6. At step 2008, the method comprises creating a connection between the display template collection and the selected database object(s) to enable the geodata to be retrieved from the selected database object(s) to the display templates of the display template collection. In the example described above, this connection was formed responsive to a user input such as a “print” command. Any suitable input can be used to trigger the connection to be formed. Because the display template collection is effectively treated as a single object, only one connection needs to be formed between the collection and the database object; there is no need for the user to individually connect each individual display template to the database. Step 2008 is analogous to step 212 described above in respect of FIG. 2, and the discussion of step 212 applies also to step 2008. In particular, the connection may be formed through a macro embedded in the display template collection which allows the data to be retrieved from the database to the display template collection. The macro may be incorporated into the collection by the user or automatically in response to user instruction to create the display template collection.

Finally, at step 2010 the method comprises populating the display templates within the display template collection with the geodata retrieved from the selected database object(s). The display template collection can then be displayed and/or printed, as described above with respect to FIG. 19. Note that the display templates of the collection are automatically and seamlessly populated with geodata based only on a selection of the database object(s). The user does not need to individually populate or configure the display templates; they simply select the templates, group them into a collection and the system then treats the collection as a single object that can be populated with geodata in response to a single user input (selection of database object(s)).

It will be appreciated that the display templates of FIGS. 15-20 may comprise display objects (such as display objects 110 and 1010 described above) configured to present geodata in the same manner as described above. Hence, discussion of populating display templates with geodata in the context of FIGS. 15-20 can in some cases involve populating display objects contained within the display templates in the manner described more fully above in relation to FIGS. 10-14.

The above description has provided a variety of examples to illustrate the disclosed methods. However, the described arrangements and methods are merely exemplary, and it will be appreciated by a person skilled in the art that various modifications can be made without departing from the scope of the appended claims. In particular, all of the geodata and geological entities from which the geodata is obtained are merely exemplary. The disclosed methods and systems can be obtained from any suitable geological entity or site, using any suitable sensors, or measuring devices.

While various specific combinations of components and method steps have been described, these are merely examples. Components and method steps may be combined or ordered in any suitable arrangement or combination. Components and method steps may also be omitted to leave any suitable combination of components or method steps.

FIG. 21 shows a block diagram of one implementation of a computing device 2100 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine.

Further, while only a single computing device is illustrated, the term “computing device” shall also be taken to include any collection of machines (e.g., computers) that individually or jointly execute a set (or multiple sets) of instructions to perform any one or more of the methodologies discussed herein. More particularly, a number of computing devices can be used to compute cross-correlations of signal data subsets independently and in parallel, as described above. Each computing device may have the structure shown in FIG. 21. Alternatively, a plurality of processors within a single computing device, such as computing device 2100, can perform the independent computations.

The example computing device 2100 includes a processor 2102, a main memory 2104 (e.g., read-only memory (ROM), flash memory, dynamic random access memory (DRAM) such as synchronous DRAM (SDRAM) or Rambus DRAM (RDRAM), etc.), a static memory 2106 (e.g., flash memory, static random access memory (SRAM), etc.), and a secondary memory (e.g., a data storage device 2118), which communicate with each other via a bus 2130.

Processor 2102 represents one or more general-purpose processors such as a microprocessor, central processing unit, or the like. More particularly, the processor 2102 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 2102 may also be one or more special-purpose processors such as an application specific integrated circuit (ASIC), a field programmable gate array (FPGA), a digital signal processor (DSP), network processor, or the like. Processor 2102 is configured to execute the processing logic (instructions 2122) for performing the operations and steps discussed herein.

The computing device 2100 may further include a network interface device 2108. The computing device 2100 also may include a video display unit 2110 (e.g., a liquid crystal display (LCD) or a cathode ray tube (CRT)), an alphanumeric input device 2112 (e.g., a keyboard or touchscreen), a cursor control device 2114 (e.g., a mouse or touchscreen), and an audio device 2116 (e.g., a speaker).

It will be apparent that some features of computer device 2100 shown in FIG. 21 may be absent. For example, one or more computing devices 2100 may have no need for display device 2110 (or any associated adapters). This may be the case, for example, for particular server-side computer apparatuses 2100 which are used only for their processing capabilities and do not need to display information to users. Similarly, user input device 2112 may not be required. In its simplest form, computing device 2100 comprises processor 2102 and memory 2104.

The data storage device 2118 may include one or more machine-readable storage media (or more specifically one or more non-transitory computer-readable storage media) 2128 on which is stored one or more sets of instructions 2122 embodying any one or more of the methodologies or functions described herein. The instructions 2122 may also reside, completely or at least partially, within the main memory 2104 and/or within the processor 2102 during execution thereof by the computer system 2100, the main memory 2104 and the processor 2102 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAS, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “identifying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method of associating geodata with a collection of display templates, the method comprising:
receiving a selection of two or more display templates configured to graphically represent geodata;
grouping the two or more display templates into a display template collection;
receiving a selection of a first database object comprising the geodata;
creating a connection between the display template collection and the first database object to enable the geodata to be retrieved from the first database object to the display template collection; and
populating the two or more display templates within the display template collection with the geodata retrieved from the first database object.

2. The computer-implemented method of claim 1, further comprising:
displaying one or more display templates of the display template collection.

3. The computer-implemented method of claim wherein each display template in the display template collection is configured to display a different type of geodata.

4. The computer-implemented method of claim 1, further comprising:
populating a first display template in the display template collection with a first type of geodata from the first database object; and
populating a second display template in the display template collection with a second type of geodata from the first database object.

5. The computer-implemented method of claim 1, wherein populating the two or more display templates within the display template collection with the geodata comprises associating the geodata with one or more display objects comprised within the two or more display templates.

6. The computer-implemented method of claim 1, further comprising:
receiving a selection of a second database object comprising geodata;
creating a connection between the display template collection and the second database object to enable the geodata to be retrieved from the second database object; and
populating the two or more display templates within the display template collection with geodata from the second database object.

7. The computer-implemented method of claim 6, further comprising displaying the geodata from the first database object and the second database object in a same display object.

8. The computer-implemented method of claim 1, wherein the first database object and/or second database object is associated with a geological entity comprising one of: a borehole, a groundwater well, a climate measurement station, a soil container, or a water container.

9. The computer-implemented method of claim 1, wherein the geodata comprises data obtained from a plurality of data sources.

10. The computer-implemented method of claim 1, further comprising:
receiving an instruction to refresh the connection between the display template collection and the first database object;
in response to receiving the instruction, retrieving updated geodata from the first database object; and
replacing the geodata populated within the two or more display templates of the display template collection with the updated geodata.

11. The computer-implemented method of claim 1, further comprising:
receiving an instruction to print a report comprising the display template collection; and
printing the report, wherein the report comprises the geodata from the first database object displayed within the two or more display templates of the display template collection.

12. A system comprising:
one or more processors; and
one or more memories having stored thereon computer-readable instructions which when executed by the one or more processors, cause the one or more processors to:
receive a selection of two or more display templates configured to graphically represent geodata;
group the two or more display templates into a display template collection;
receive a selection of a first database object comprising the geodata;
create a connection between the display template collection and the first database object to enable the geodata to be retrieved from the first database object to the display template collection; and
populate the two or more display templates within the display template collection with the geodata retrieved from the first database object.

13.-14. (canceled)

15. A graphical user interface, GUI, configured to display geodata, comprising:
a display template selection area comprising a display template collection, the display template collection comprising two or more display templates configured to graphically represent geodata; and
a database object selection area comprising a list of database objects available for selection,
wherein the GUI is configured such that, in response to selection of a database object from the list of database objects, the geodata is retrieved from the database object and populated within the two or more display templates of the display template collection.

16. The system of claim 12, further comprising instructions, which when executed by the one or more processors, cause the one or more processors to:
display one or more display templates of the display template collection.

17. The system of claim 12, wherein each display template in the display template collection is configured to display a different type of geodata.

18. The system of claim 12, further comprising which when executed by the one or more processors, cause the one or more processors to:
populate a first display template in the display template collection with a first type of geodata from the first database object; and
populate a second display template in the display template collection with a second type of geodata from the first database object.

19. The system of claim 12, wherein populating the two or more display templates within the display template collection with the geodata comprises associating the geodata with one or more display objects comprised within the two or more display templates.

20. The system of claim 12, further comprising which when executed by the one or more processors, cause the one or more processors to:
receive a selection of a second database object comprising geodata;
create a connection between the display template collection and the second database object to enable the geodata to be retrieved from the second database object; and
populate the two or more display templates within the display template collection with geodata from the second database object.

21. The system of claim 20, further comprising which when executed by the one or more processors, cause the one or more processors to:
display the geodata from the first database object and the second database object in a same display object.

22. The system of claim 12, wherein the first database object and/or second database object is associated with a geological entity comprising one of: a borehole, a groundwater well, a climate measurement station, a soil container, or a water container.
